(19) United States
(12) Patent Application Publication
(10) Pub. No.: US 2013/0340765 A1
(43) Pub. Date: Dec. 26, 2013

(54) Sway Free Sling Stand

(71) Applicant: Louis Ceruzzi, Atlanta, GA (US)

(72) Inventor: Louis Ceruzzi, Atlanta, GA (US)

(21) Appl. No.: 13/531,781

(22) Filed: Jun. 25, 2012

(51) Int. Cl. A61G 15/00

(52) U.S. Cl. 128/845

(57) ABSTRACT

The “Sway Free Sling Stand” is used to suspend sex slings, swings and bondage gear through the use of D-Rings and Threaded Inserts. The stand is self supporting, transportable via all major airlines, easily storable, assembles without tools or hardware and is virtually free of twisting and sway due to the arrangement of the interlocking top and bottom tubes where one tube uses the corresponding, interlocked tube to provide stability and strength to the next tube. The stand is completely powder coated to provide a durable and attractive finish and features four adjustable, threaded feet that can be adjusted to provide further stability on uneven surfaces.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The “Sway Free Sling Stand” was designed to support various slings and bondage systems used to support human beings for use as a means to suspend or elevate for sexual activity. The present invention relates generally to an apparatus for a stand. Specifically, the apparatus is a collapsible stand for mounting sex slings/swings. U.S. patent classification: 297/273; 5/122; 5/929 (Chairs and Seats—Oscillating suspender connected to or through adjunctive rest, Beds—Hammocks—Fabric Hammocks, and Facilitating Sexual Relations, respectively).

Sex slings/swings are enjoyed by many people, and are particularly useful for individuals with muscular weakness or arthritis who cannot otherwise enjoy sexual activities. Unfortunately, often times these devices are difficult to set up and require special mounting means. Often, individuals must place eyebolts in ceilings, walls, or doorframes. The sway free sling stand is an apparatus, which provides a reliable frame from which to hang sex slings/swings.

### BRIEF SUMMARY OF THE INVENTION

The “Sway Free Sling Stand” is a transportable, storable, modular frame, constructed of tubular steel which interlocks through the use of different sized tubing forming “slip fits” and uses no hardware to secure the frame. Within the frame, various mounting points, both welded and threaded inserts are located for suspension of sex slings, swings and bondage equipment such as ropes and chains. The general idea of the sway free sling stand is to provide an apparatus whereby users can attach slings/swings for sexual use, without experiencing any sway from the stand.

The variance in functionality with the present invention derives from its structural differences, which provide for a stand that does not move, or sway, while in use. The structural design, as seen in the drawings, provides this non-sway improvement in functionality. Therefore, the object of the invention is to provide a more stable frame where individuals can mount swings/stands for sexual use, without having to experience any movement deriving from the stand.

### BRIEF DESCRIPTION OF THE SEVERAL VIEWS OF THE DRAWING

FIG. 1: Shows a full view of the assembled stand consisting of 4-Bottom Tubes, 4-Long Leg Tubes, 4-Short Leg Tubes, 4-Top Tubes & 4-Adjustable Feet.

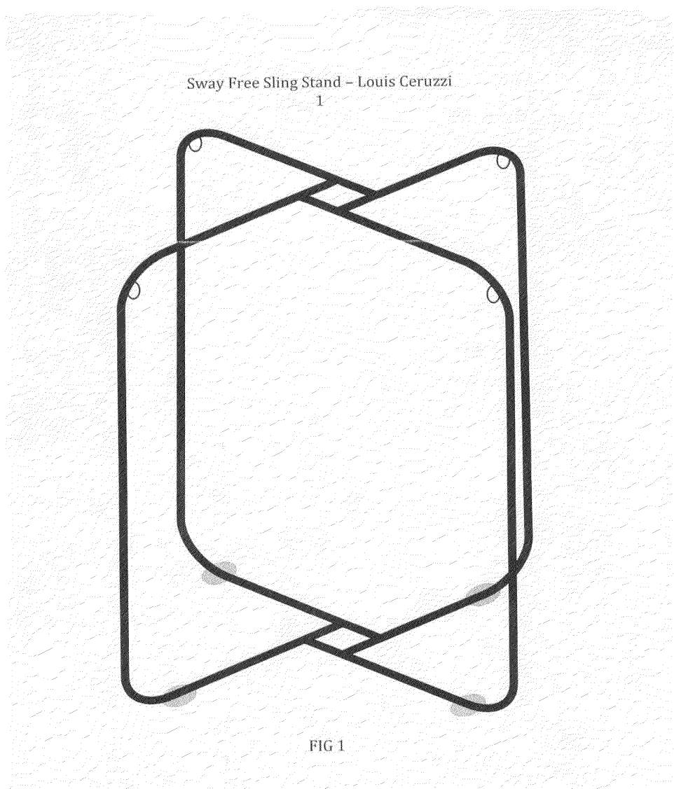

FIG. 2: Shows a birds eye view of the interlocking bottom and top sections. Tubes shown in grey, slide into the long black tubes, which prevents the long tube from rotating. The top bars assemble to make a mirror image of the bottom assembly.

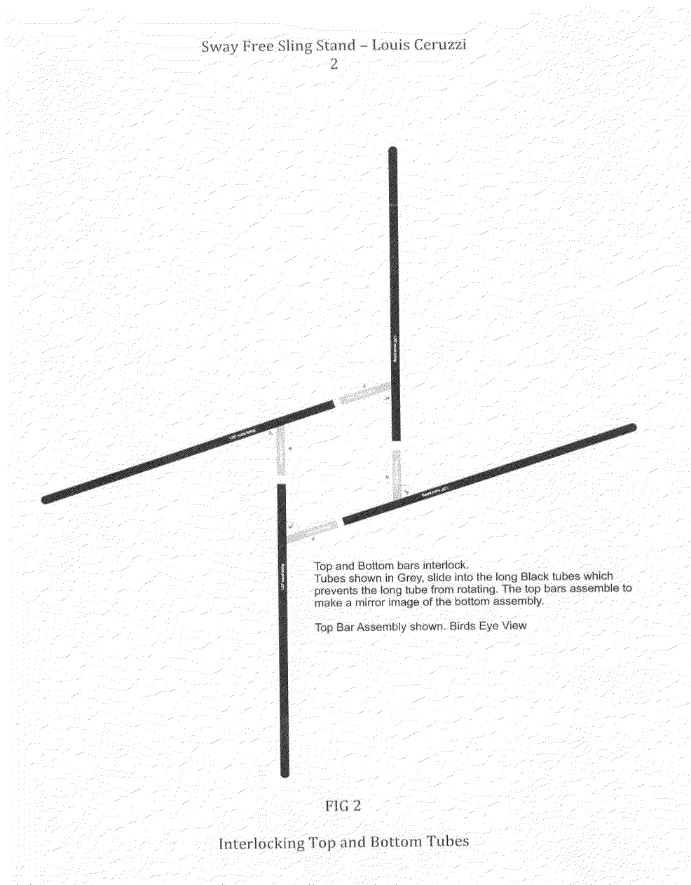

FIG. 3: Shows the interlocking top bar in detail. Includes the top base tubes and the D-Ring for hanging the sling/swing.

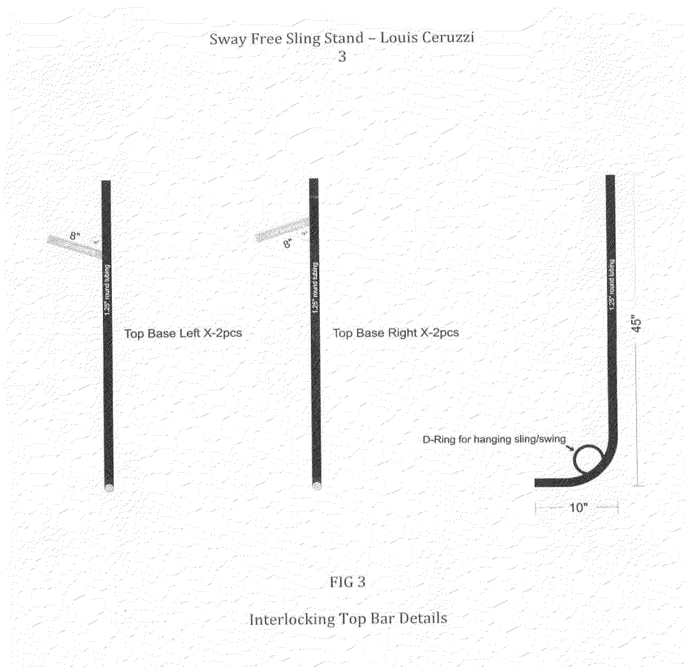

FIG. 4: Shows the interlocking bottom bar details. Includes the bottom base tubes.

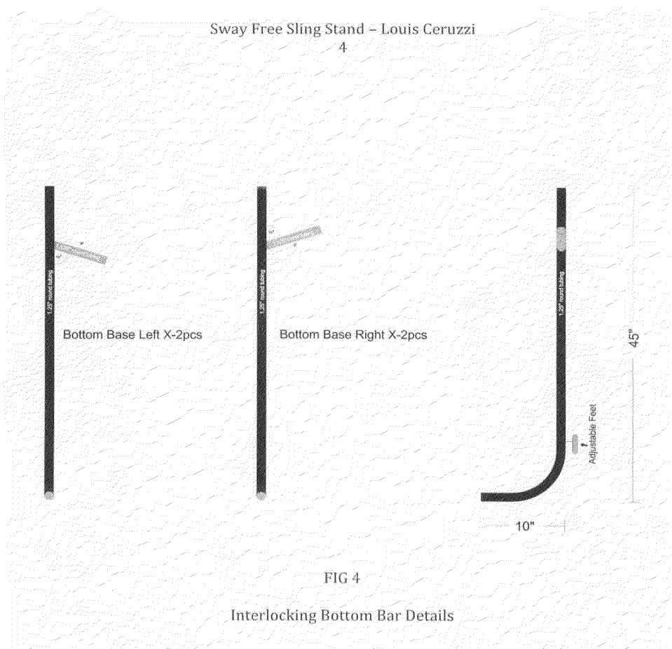

FIG. 5: Shows the short and long leg details. One short and one long leg fit between each top and bottom bar. Tubes are held together with 1.125″ tubes as a “slip fit” shown in grey.

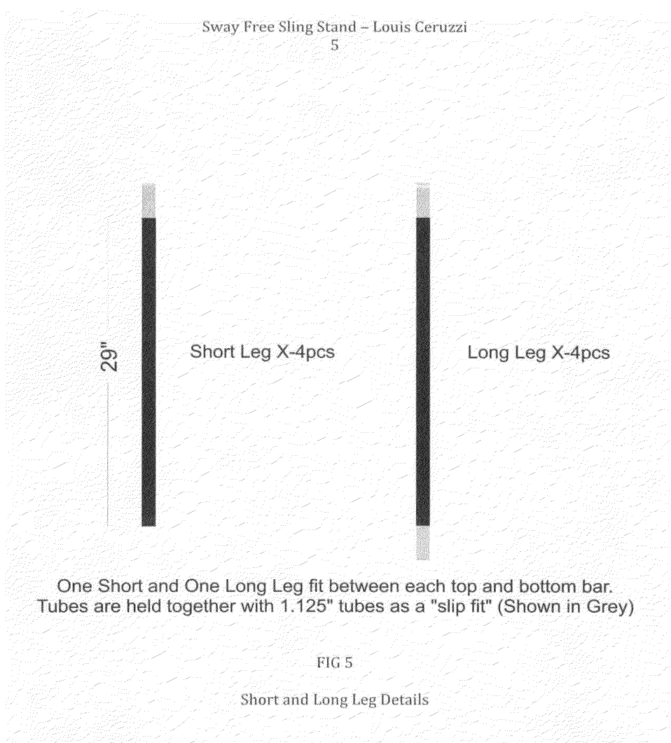

### DETAILED DESCRIPTION OF THE INVENTION

The “Sway Free Sling Stand” is made of 1.25″ round steel tubing and consists of 4-Top bars, 4-Bottom bars, 4-Short straight bars, 4-Long straight bars and 4-adjustable feet. The top and bottom bars are mandrel bent to transition from the horizontal to the vertical and interlock at the center by sliding one bent bar onto the corresponding bent bar. This interlocking design is what gives the frame it's structural integrity and rigidity and “Sway Free” abilities. The straight tubes use a smaller 1.125″ round tube which is welded into one end of the tube to form a “male/female” slip fit which allows the frame to be assembled without tools or additional hardware. The frame features “D-rings” which are welded in various locations to suspend the sex sling/swing and uses threaded inserts (riv-nuts) for various mounting points for bondage and accessories. The frame includes adjustable threaded feet for use on uneven surfaces and is completely powder coated in various colors to provide protection and lasting beauty.

I claim:

1. That the “Sway Free Sling Stand” is designed and executed in such a way as to eliminate virtually all movement in the stand. This is accomplished in the way the top and bottom bars interlock in the center of the stand and this arrangement of the tubing and the “slip fit” joints are the heart of the design. In order for one bar to twist, under load, it must turn the other tube, which is in fact connected to the corresponding tube at an 18 degree angle. One tube cannot twist without twisting the other tubes, which cannot happen.
